(19) United States
(12) Patent Application Publication
(10) Pub. No.: US 2026/0289780 A1
(43) Pub. Date: Sep. 24, 2026

(54) MULTIFRACTAL ANALYSIS OF SURFACE POTENTIAL FOR CANCER DIAGNOSIS

(71) Applicants: Dmitri VORONINE, Tampa, FL (US); Phat Kim HUYNH, Tampa, FL (US); Dang NGUYEN, Tampa, FL (US); Grace Ann BINDER, Tampa, FL (US); Sharad AMBARDAR, Tampa, FL (US); Trung Quoc LE, Tampa, FL (US); UNIVERSITY OF SOUTH FLORIDA, Tampa, FL (US)

(72) Inventors: DMITRI VORONINE, Tampa, FL (US); PHAT KIM HUYNH, Tampa, FL (US); DANG NGUYEN, Tampa, FL (US); GRACE ANN BINDER, Tampa, FL (US); SHARAD AMBARDAR, Tampa, FL (US); TRUNG QUOC LE, Tampa, FL (US)

(21) Appl. No.: 19/474,349

(22) PCT Filed: Apr. 12, 2024
(86) PCT No.: PCT/US2024/024372

§ 371 Date: Oct. 10, 2025

Related U.S. Application Data
(60) Provisional application No. 63/495,881, filed on Apr. 13, 2023.

(51) Int. Cl. G06T 7/00; G06T 7/62; G06V 20/69

(52) U.S. Cl. CPC G06T 7/0014; G06T 7/62; G06V 20/698; G06T 2207/10056; G06T 2207/30024; G06V 2201/03

(57) ABSTRACT

Methodology of determination of whether a target biological cell is cancerous based on measurement of the surface potential of such cell and comparing it with the measurement of the surface potential of a normal cell using multifractal analysis to characterize the time-averaged spatial fluctuations of the surface potential. Determinative increase of multifractality of the surface potential is indicative of the cancerous nature of the target cell. Multifractality in surface potential can also be used as a novel biomarker for novel drug delivery methods based on bioelectric activation.

### CROSS REFERENCE TO RELATED APPLICATIONS

This International Patent application claims the benefit of U.S. Provisional Patent Application No. 63/495,881 filed on Apr. 13, 2023, the entire contents of which are incorporated by reference herein, for all purposes.

### TECHNICAL FIELD

The present invention relates to methodologies of characterizing cancerous cells in a cell culture and, more particularly, to a methodology of identifying a cancerous cell based on results of multifractal analysis of images representing an electrostatic parameter such as the surface potential of the cell with nanoscale resolution.

### RELATED ART

Breast and ovarian are the most frequent types of cancer among women worldwide. Morbidity and mortality of cancer are substantially decreased with early detection. Cytological screening tests have decreased mortality. However, these methods have insufficient sensitivity and are time-consuming in both analysis and training of professionals with subjective manual diagnosis. More accurate tests may substantially decrease the cost and patient inconvenience. Tumorigenesis is a complex process with an uncontrolled growth of cells that ignore apoptotic signals triggered by cell cycle dysregulation and modulate cell survival pathway signaling. This process involves remodeling of the extracellular matrix, accompanied by morphological and electrochemical changes in the plasma membrane. Nanoscale imaging techniques investigate these changes with a high spatial resolution to better understand tumorigenic mechanisms.

The plasma membrane resting potential was shown to undergo abnormal depolarization in cancer cells (see, for example, B. Chernet and M. Levin, “Endogenous voltage potentials and the microenvironment: bioelectric signals that reveal, induce and normalize cancer,” Journal of clinical & experimental oncology, 2013). Various mechanisms of membrane potential regulation have been investigated that involve cell signaling pathways mediated by the disrupted activities of ion channels, pumps, and transporters. The potential difference between tumor and paratumor was found for several types of cancer, and the resulting depolarization was correlated with metastasis (see, for example, H. Zhao et al., “Electrostatic potential difference between tumor and paratumor regulates cancer stem cell behavior and prognose tumor spread,” Bioengineering & Translational Medicine, p. e10399, 2022). The membrane potential has been identified as an important bioelectric marker that reflects the changes in cellular activities.

The common methods of membrane potential measurements based on electrodes and voltage-sensitive dyes have a lack of imaging and a limited spatial resolution, respectively. Recently, a KPFM method was introduced—is a nanoscale electrostatic force imaging technique based on the contact potential difference (CPD) between a scanning probe tip and sample (see W. Melitz et al., “Kelvin probe force microscopy and its application,” Surface science reports, vol. 66, no. 1, pp. 1-27, 2011). KPFM has a high spatial resolution of less than 10 nm, which is determined by the size of the tip apex. While it was previously used in a variety of biomedical applications such as mapping the surface potential of biomolecules (including DNA, proteins, and plasma membrane of cells) to reveal biomolecular interactions at the single-molecule level, the related art has not addressed the use of the KPFM methodology for identification of cancer-particularly the identification of cancerous nature of a biological cell.

A more conventional type of force microscopy—the atomic force microscopy (AFM) providing the shape of a surface being imaged with nanoscale resolution—has previously been used for cancer detection (and, in particular, specific cell properties identified with the use of the AFM—such as cell stiffness, adhesion, and elasticity were used to identify cancerous tissue (see, for example, S. E. Cross et al., “AFM-based analysis of human metastatic cancer cells,” Nanotechnology, vol. 19, no. 38, p. 384003, 2008). However, as the related art clearly recognized—in some cases AFM morphological imaging cannot differentiate between normal and cancer cells, while adhesion maps showed differences in fractality (M. E. Dokukin et al., in Physical review letters, vol. 107, no. 2, p. 028101, 2011). Both fractal and multifractal analyses were previously used for cancer diagnosis. Fractal geometry, for example, was used to describe the morphology of cancer cells and tissues by a single parameter, the fractal dimension, as a diagnostic biomarker (see, R. Sedivy and R. M. Mader, “Fractals, chaos, and cancer: do they coincide?,” Cancer investigation, vol. 15, no. 6, pp. 601-607, 1997.) However, while fractal dimension is suitable for the characterization of monofractal objects that have the same scaling exponent at different scales, a more complex organization (e.g., cellular membrane) exhibits different fractal exponents at different scaling ranges resulting in several interwoven fractal sets, which are better described by the multifractal formalism (see B. B. Mandelbrot, Multifractals and 1/f noise: Wild self-affinity in physics (1963-1976). Springer, 2013) Both fractal and multifractal analyses significantly improved the diagnostic efficiency of AFM imaging for cancer detection. And yet, the interpretation of complex morphologies obtained with the use of AFM imaging remains limited due to the lack of corresponding molecular information.

There remains a need in methodology allowing for identification of a cancerous nature of a given cell that obviates the limitations of the force-microscope-based approaches of related art.

### SUMMARY OF THE INVENTION

Embodiments of the invention provide an article of manufacture that includes a processor and a non-transitory computer readable medium that includes computer readable program code disposed therein for controlling operation of an apparatus, which apparatus includes a force microscope configured to characterize a surface potential of a target biological sample. Here, the computer readable program code contains a series of computer readable program steps to carry out at least the following steps: a step of acquiring a first force microscopy image that represents the surface potential of the target biological sample, the step of providing a second force microscopy image representing a surface potential of a reference biological sample that is nonmalignant, and a step of comparing results of multifractal analysis of the first and second force microscopy images. (In at least one specific case, the article of manufacture may also include the force microscope apparatus itself, operably connected with the processor.) Optionally, the computer readable program steps may be configured to determine parameters of multifractal analysis of the second force microscopy image stored on a non-transient storage medium or to receive such parameters stored on the non-transient storage medium. Alternatively or in addition, and substantially in every implementation of the article, the readable program steps may be configured to carry out the process of determining a difference between a first width of a first multifractal spectrum of the first force microscopy image and a second width of a second multifractal spectrum of the second force microscopy image. At least when this is the case, the process of determining may optionally include determining a difference between widths of first and second singularity multifractal spectra of the respectively corresponding first and second force microscopy images and/or, optionally, a step of producing indicia identifying the biological sample as a cancerous biological sample when the first width is substantially larger than the second width.

Embodiments additionally provide for use of an apparatus that is configured to acquire a first image of a spatial distribution of an electrostatic characteristic of a target biological cell and to perform, with the use of a processor, multifractal analysis of the first image to identify whether the target biological cell is a cancerous cell. The apparatus may be configured to generate user-perceivable indicia representing whether the biological cell is the cancerous cell and/or the electrostatic characteristic may include a difference between a surface potential of a surface of the cell and a surface potential of an electrically conducting element moving above the surface of the biological cell. In at least one specific implementation, the apparatus may include a force microscope configured to produce said first image. Optionally—and substantially in every implementation of the use of the apparatus—the processor may be further configured to procure a second image of a spatial distribution of an electrostatic characteristic of a reference biological cell that is nonmalignant and to determine whether a difference between a first parameter of the multifractal analysis of the first image and a second parameter of the multifractal analysis of the second image. When the processor is so configured, each of the first parameter and the second parameter may be chosen to includes at least one of: a parameter of a Rényi spectrum of the first image and the second image, respectively, determined with the use of a mean value thresholding; and a width of a multifractal spectrum of the first image and the second image, respectively, determined with the use of adaptive thresholding. In the case when each of the first parameter and the second parameter includes a parameter of the corresponding Rényi spectrum, such parameter of the corresponding Rényi spectrum may be defined as an entropy dimension D₁ and/or a correlation dimension D₂. In addition or alternatively, when each of the first parameter and the second parameter includes a width of a corresponding multifractal spectrum, such width may be defined via a singularity exponent range Δα(4). Alternatively or in addition, and in at least once specific implementation of the use of the apparatus, the indicia may be defined to represent a difference between the first parameter of the multifractal analysis of the first image and the second parameter of the multifractal analysis of the second image.

Embodiments further provide the use of a Kelvin probe force microscopic imaging of a target biological cell to identify the biological cell as a cancerous cell or as a nonmalignant cell by assessing a first width of a multifractal spectrum of a spatial distribution of a surface potential of the target biological cell. Here, the use may include a step of assessing a second width of a multifractal spectrum of a spatial distribution of a surface potential of a reference nonmalignant biological cell and identifying the target biological cell as the cancerous cell when the first width is substantially smaller than the second width.

Embodiments additionally provide a computer implemented method for identifying a cancerous biological cell. Such method includes at least a step of acquiring, with the computer, a first image of a target biological cell and a second image of a reference nonmalignant biological cell (here, each of the first image and the second image represents a spatial distribution of surface potential of a corresponding biological cell of the target and reference nonmalignant cells), a step of performing, with the computer, (i) multifractal analysis of the first image to generate a first multifractal characteristic representing the chosen biological cell, and (ii) multifractal analysis of the second image to generate a second multifractal characteristic representing the reference nonmalignant biological cell, and a step of creating, with the computer, indicia representing whether the chosen biological cell is the cancerous biological cell based on a difference between a first parameter of the first characteristic and a second parameter of the second characteristic. Optionally, each of the first and second characteristics may include at least one of a Rényi spectrum, a multifractal spectrum, and a singularity exponent range, and/or the step of creating may include determining at least one of (i) a difference between entropy dimensions D₁ of the respectively corresponding Rényi spectra of the first and second images, (ii) a difference correlation dimensions D₂ of the respectively corresponding Rényi spectra of the first and second images, and (iii) a difference between widths of respectively corresponding multifractal spectra of the first and second images. Alternatively or in addition, and substantially in every implementation, the method may include at operating a force microscope apparatus while maintaining a tip-to-sample potential (TSP) difference to remain substantially constant to acquire each of the first and second images (here, the TSP difference is a difference between a surface potential of a tip of a probe of the force microscope and a surface potential of the corresponding biological cell of the target and reference nonmalignant cells). When this is the case, the tip of a probe of the force microscope of the apparatus is coated with an electrically conducting material. Alternatively or in addition, when the first parameter and the second parameter are, respectively, a first width of a multifractal spectrum of the first image and a second width of a multifractal spectrum of the second image, the step of creating may include identifying whether the second width is greater than the first width, and/or—when the first parameter and the second parameter are, respectively, a first width of a multifractal spectrum of the first image and a second width of a multifractal spectrum of the second image—each of these first and second widths may be determined with the use of an adaptive thresholding as a corresponding singularity exponent range of, respectively, the multifractal spectrum of the first image and the multifractal spectrum of the second image. Optionally, and at least in one specific implementation of the method, the step of acquiring may include acquiring the first and second images with a nanoscale resolution.

### BRIEF DESCRIPTION OF THE DRAWINGS

The invention will be more fully understood by referring to the following Detailed Description of Specific Embodiments in conjunction with the Drawings, of which:

FIG. 1 is a multi-graph drawing that includes graph-windows (a), (b), (c), (d), €, (f), (g), (h), (i), (j), (k), (l), (m), (n), and (o), and that illustrates the fractal and multifractal analysis procedures applied to AFM- and KPFM-images (procured with the use of force microscopes of FIGS. 5A, 5B) of normal (MCF-10a, SHT290) and cancer (MDA-MB-231, ES-2) cells. Scale bar is 10 μm.

FIGS. 2A, 2B, 2C, 2D illustrate the results of fractal analysis of AFM and KPFM images using the box-counting method with adaptive thresholding. Dependence of the local fractal dimension D_{f} as a function of the box size for individual cells (thin dashed lines) and mean data (thick solid lines).

FIG. 3 is a multi-graph drawing that includes graph-windows (a) through (l) and illustrates Rényi spectra (graph-windows (a) through (d)), multifractal spectra (graph-windows (e) through (h)), and singularity exponent range (graph-windows (i) through (l)) determined from multifractal analysis of AFM and KPFM images of normal and cancer cells, with the use of adaptive thresholding approach, for individual areas (dashed lines) and averages (solid lines). Vertical dashed lines mark the values of D₀, D₁ and D₂ multifractal parameters.

FIG. 4 is a multi-graph drawing that includes graph-windows (a) through (h) and presents comparison of the multifractal parameters D₀, D₁, D₂, and Δα(4) from the combined and separate cytoplasm and nucleus regions using the adaptive threshold approach.

FIGS. 5A, 5B are schematic diagrams of the morphological AFM-based and surface potential KPFM-based imaging of cells, respectively.

FIG. 6 contains multiple graph-windows (a) through (t) and provides typical representative examples of the AFM (graph-windows (a), (b)) and KPFM (graph-windows (c), (d)) images of the breast cell lines and their respectively-corresponding binarized images (graph-windows (e) through (l)), local fractal dimensions (graph-windows (m) through (p)), and multifractal spectra (graph-windows (q) through (t)) obtained using the adaptive and median value thresholding approaches as described.

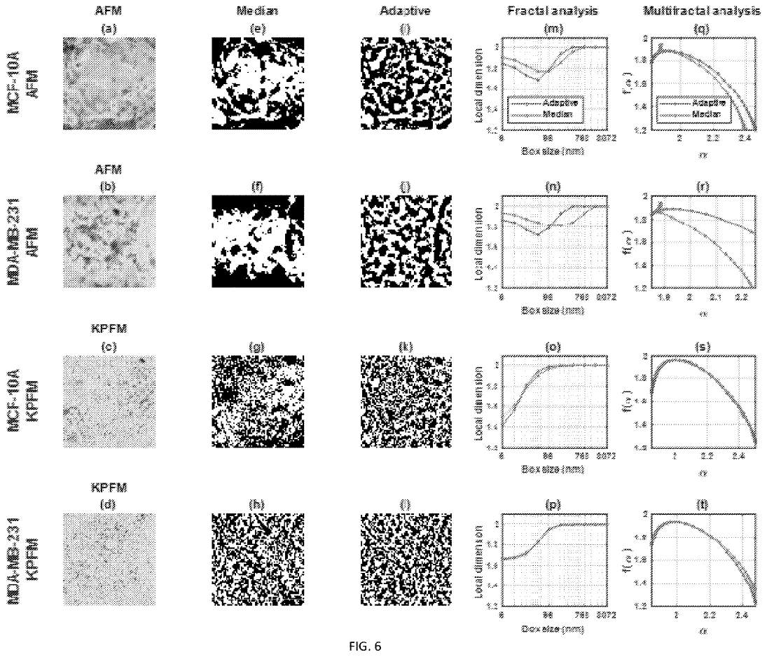

FIG. 7 contains multiple graph-windows (a) through (t) and presented: Typical examples of the AFM (graph-windows (a), (b)) and KPFM (graph-windows (c), (d)) images of the ovarian cell lines and their corresponding binarized images (graph-windows (e) through (l)), local fractal dimensions (graph-windows (m) through (p), and multifractal spectra (graph-windows (q) through (t)) obtained using the adaptive and median value thresholding approaches as described.

FIGS. 8A, 8B, 8C, and 8D illustrate typical representative AFM and KPFM profiles obtained from the 3×3 μm² scan areas used in the multifractal analysis.

FIGS. 9A, 9B, 9C, and 9D illustrate the results of fractal analysis of AFM and KPFM images using the box-counting method with the median thresholding approach. Dependence of the local fractal dimension D_{f} as a function of the box size for individual cells (thin dashed lines) and mean data (thick solid lines).

FIG. 10 is a multi-graph drawing that includes graph-windows (a) through (l) and illustrates Rényi spectra (graph-windows (a) through (d)), multifractal spectra (graph-windows (e) through (h)), and singularity exponent range (graph-windows (i) through (l)) determined from multifractal analysis of median AFM and KPFM images of normal and cancer cells for individual areas (dashed lines) and averages (solid lines). Vertical dashed lines mark the values of D₀, D₁ and D₂ multifractal parameters.

FIG. 11 is a multi-graph drawing that includes graph-windows (a) through (h) and presents comparison of the multifractal parameters D₀, D₁, D₂, and Δα(4) from the combined and separate cytoplasm and nucleus regions using the median threshold approach.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

### General

The embodiments of the present invention, described below, detail a methodology of identification of whether a given target biological sample—such as a biological cell, for example—is cancerous or nonmalignant with the use of judiciously identified parameters of the results of multifractal analysis of an image of an electrostatic characteristic of the target biological sample. As the skilled person will readily appreciate from the discussion below, it was empirically determined that specific outcomes of the multifractal analysis of such an image—not those of a fractal analysis—are responsive and/or sensitive to the more complex organization of the portion of the cancerous cell associated with the cellular membrane as compared to that of the nonmalignant cell. In particular, the idea of the present invention stems from the realization that various proteins, for example—which have affinity to the cellular membrane in a cancerous cell and for that reason attach to the cellular membrane—while not necessarily affecting the cell surface morphology (as compared to that of a non-cancerous cell) influence, nevertheless, the surface potential, and from the realization that multifractality of the images representing a surface potential of the cell is increased for cancerous cells as compared with that for non-cancerous cells. Altogether, the problem of reliable and repeatable identification of whether a target biological cell (or cell culture) is cancerous or not has been solved by identifying one or more of specific parameters (describing the results of a multifractal analysis of an image of an electrostatic characteristic—for example, a surface potential) of such target cell that are different from the corresponding parameters describing the non-cancerous cell. Each of these parameters—and, in particular, the width of a multifractal spectrum—is identified as and can be used as a biomarker of the cancerous nature of the target biological cell. Implementation of the idea of the invention can be carried out with a system that includes a Kelvin probe force microscope apparatus complemented with a processor (microprocessor, programmable electronic circuitry) controlled by specific instructions stored in a non-transitory tangible storage medium and configured to implement the determination of such biomarker(s).

Specifically, the implementation of the idea of the invention is demonstrated below with the use of the fractal and multifractal analysis of morphological (AFM) and bioelectric (KPFM) images of ovarian and breast cells (with understanding that these specific cells are but examples, and that embodiments of the invention can be used for identification of various other cancerous cells).

Kelvin probe force microscopy (KPFM) is a modality of the general atomic force microscopy technique in which the contact potential difference (CPD) between a conductive probe of the force microscope and a sample is extracted by observing the electrostatic interaction between probe and sample at the nanoscale level.

The high spatial resolution allows for probing a broad range of scales, covering more than three orders of magnitude, from <10 nm to tens of micrometers. Demonstration of the operability and utility of the embodiments of the invention is demonstrated with the use of a box-counting method to determine the fractal dimensions with significant variations at different scaling ranges. Multifractal analysis was employed for a more precise characterization of the scaling behavior, which showed a significant difference between the surface potential of the normal and cancer cells. The substantially improved efficiency in detecting cancer with the use of KPFM imaging followed by multifractal analysis of the results of such imaging as compared to the AFM-based cancer detection was clearly demonstrated. Accordingly, one of implementations of the invention manifests in use of an apparatus (that is configured to acquire a first image of a spatial distribution of an electrostatic characteristic of a target biological cell and that is configured to perform, with the use of a processor, multifractal analysis of the first image) to identify whether the target biological cell is a cancerous cell. A related embodiment manifests in use of a Kelvin probe force microscopic imaging of a target biological cell to identify the biological cell as a cancerous cell or as a nonmalignant cell by assessing a first width of a multifractal spectrum of a spatial distribution of a surface potential of the target biological cell.

Notably, all technical terminology used in this disclosure—and, in particular, that describing various aspects and intricacies of multifractal analysis—is well known in related art and for that reason does not require any additional definition(s) and/or explanations: the reader is referred, for example, to B. B. Mandelbrot, The fractal geometry of nature. W H freeman New York, 1982; R. Lopes and N. Betrouni, “Fractal and multifractal analysis: a review,” Medical image analysis, vol. 13, no. 4, pp. 634-649, 2009; J. d. D. H. Velázquez, S. Mejía-Rosales, and A. G. Goicochea, “Fractal properties of biophysical models of pericellular brushes can be used to differentiate between cancerous and normal cervical epithelial cells,” Colloids and Surfaces B: Biointerfaces, vol. 170, pp. 572-577, 2018 (the disclosure of each of which is incorporated herein by reference). Also incorporated by reference herein is the publication of “Multifractality in Surface Potential for Cancer Diagnosis” in J. of Phys, Chem. B, 2023, 127, 6867-6877, by P. K. Huynh et al. In addition, the disclosure of each other publication referred to in this disclosure is also incorporated by reference herein.

### MATERIALS AND METHODS

### (A) Sample Preparation.

### (A.1) SHT290 and ES-2 Cell Lines

The human ovarian cancer ES-2 CCOC cell line (American Type Culture Collection, USA) was cultured in MCDB 131: Media 199 (1:1 ratio) and McCoy's medium, respectively, supplemented with 10% FBS, 100 units/ml of penicillin and 100 μg/ml of streptomycin. The immortalized normal human endometrial stromal cell line, SHT290 (Kerafast, USA) was maintained in F12K: Media 199 (1:1 ratio) and supplemented with 5% FBS, 0.1% Mito, 2 μg/ml of human insulin, 100 units/ml of penicillin and 100 μg/ml of streptomycin. All cell cultures were passaged less than 10 times. Cell cultures were maintained in an incubator at 37° C. and 5% CO₂ atmosphere.

### (A.2) MCF-10A and MDA-MB-231 Cell Lines.

MCF-10A cells (Michigan Cancer Foundation) are a non-tumorigenic, immortalized mammary epithelial cell line, while MDA-MB-231 cells are triple-negative metastatic breast cancer epithelial cells and were grown according to ATCC guidelines.

### (B) Fixation.

All cells were cultured on atomically flat gold substrates (Tedpella) as required for KPFM measurements. Cells were washed with phosphate-buffered saline (PBS) before and after fixation to remove residual media or fixative solution, respectively. Samples were fixed using 4% paraformaldehyde (PFA) for 15 min at room temperature. After washing, fixed cells were stored in PBS with 0.01% sodium azide. Samples were rinsed with methanol prior to analysis.

### (C) AFM and KPFM Measurements.

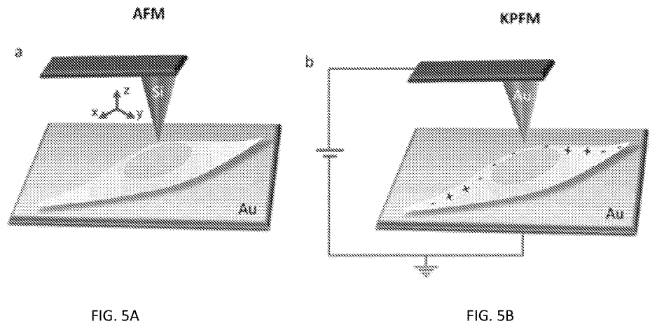

Both AFM and KPFM measurements were performed in tapping mode with an average tip-sample distance of 20 nm. AFM measurements were performed using Si tip, whereas KPFM measurements were performed using a conductive Au-coated Si tip. All images used for fractal and multifractal analysis were acquired with 3×3 μm² scan sizes, 512×512 data point resolution, and with a pixel size of ~6 nm. AFM and KPFM imaging were performed in air at ambient temperature (see schematic diagrams of FIGS. 5A, 5B illustrating AFM-imaging and KPFM-imaging performed on a cell, respectively).

### (D) Image Sampling and Image Binarization Using Adaptive and Median Thresholding.

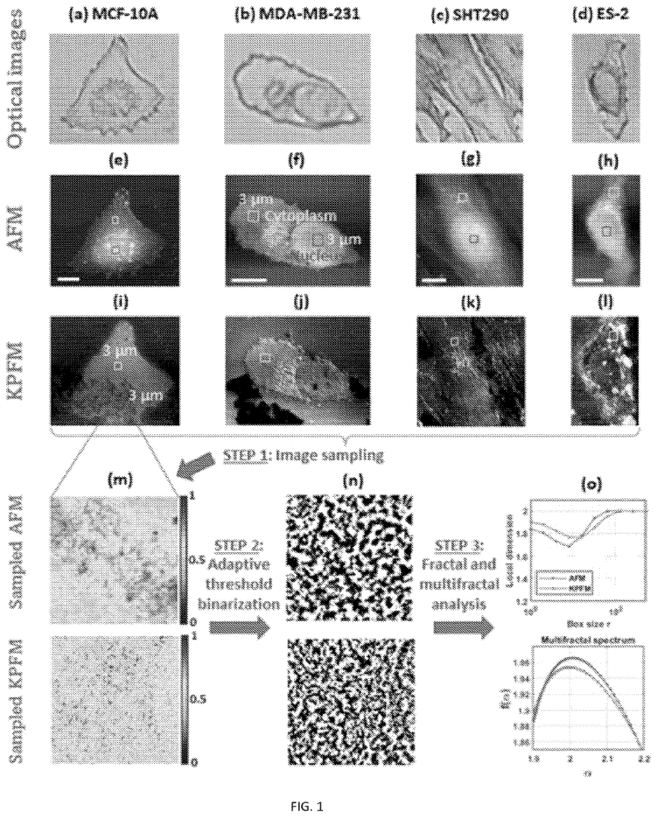

FIG. 1, containing graph-windows (a) through (o), shows the typical examples of the optical (graph windows (a) through (d)), AFM (graph-windows (e) through (h)) and KPFM (graph-windows (i) through (l)) images of the 37four cell lines used in this work. The cancer detection procedure involved the following steps. In step 1, the simultaneous AFM/KPFM image sampling was performed by scanning 3×3 μm areas selected on the cytoplasmic and nucleus parts of the cells with 512×512 pixel density as described in the Methods section (graph-windows (m)). After normalization, in step 2, the image binarization was performed using either the adaptive threshold or median methods (graph-window (n)). In step 3, either the fractal or multifractal analysis was performed (graph-windows (o)) that delivered parameter(s) for the statistical analysis.

In other words, the idea of the invention was carried out with the use of an article of manufacture that included a processor and a non-transitory computer readable medium comprising computer readable program code disposed therein for controlling operation of an apparatus, which apparatus included a force microscope configured to characterize a surface potential of a target biological sample. The employed computer readable program code contained a series of computer readable program steps to carry out the process of acquiring a first force microscopy image representing the surface potential of the target biological sample, the process of providing a second force microscopy image representing a surface potential of a reference biological sample that is nonmalignant, and the process of comparing results of multifractal analysis of the first and second force microscopy images.

To convert 2D gray-scale AFM/KPFM images to binary images, two image binarization methods were used: adaptive thresholding and median thresholding. The adaptive image thresholding technique is a method known in related art as the Bradley's method (see D. Bradley and G. Roth, “Adaptive thresholding using the integral image,” Journal of graphics tools, vol. 12, no. 2, pp. 13-21, 2007) in which the method binarizes the gray-scale image using a locally adaptive threshold. The threshold was estimated for each pixel utilizing the local mean intensity around the neighborhood of the pixel. The adaptive method uses a neighborhood size of ~⅛^{th} of the image size (64 pixels). If the current pixel value is less than the computed threshold, then it is set to black (i.e., value 0), otherwise, it is set to white (i.e., value 1). The median thresholding image binarization uses the median value of all pixels as a hard threshold and set the pixels whose values are larger than the median to black and set them to white otherwise.

### (E) Fractal and Multifractal Analyses.

### (E.1) Fractal Analysis

Fractal dimension is a measure of the space-filling capacity of a fractal object relative to its embedding space. Generally, the relationship between the number of coverings (e. g. boxes in the box-counting method) N(a) and the scaling factor a (e. g. box length) is expressed as

$$N ( a ) ∝ {a}^{- D} \qquad ( 1 )$$

where D is the fractal dimension that can take positive non-integer values. Equation (1) represents the scaling law, which describes self-similarity of a fractal object using a single parameter. The fractal dimension D was estimated by the box-counting method (see M. Wu, W. Wang, D. Shi, Z. Song, M. Li, and Y. Luo, “Improved box-counting methods to directly estimate the fractal dimension of a rough surface,” Measurement, vol. 177, p. 109303, 2021) using the fractal analysis MATLAB toolbox by counting the number of boxes N(a) with different side length a as

$$D = {lim}_{a \to 0} \frac{ln N ( a )}{ln ( \frac{1}{a} )} . \qquad ( 2 )$$

However, a single parameter describing the monofractal geometry is limited in the ability to completely differentiate the complex scaling behaviors of many real-life objects. This is attributed to the fact that the fractal dimension D only characterizes the average fractality of multifractal objects via a simple scaling law.

### (E.2) Multifractal Analysis

Multifractal analysis addresses the limitations of the fractal analysis by providing a local description of the complex scaling behavior of biomedical images, represented as a spectrum of singularity exponents f(α) (see, for example, N. V. Guz et al., in Nanomedicine: Nanotechnology, Biology and Medicine, vol. 11, no. 7, pp. 1667-1675, 2015). In the case of the binarized AFM/KPFM images, the local mass density Pᵢ(a) of the box centered at image location xᵢ with side length a is

$${P}_{i} ( a ) = \frac{{N}_{i} ( a )}{N} , \qquad ( 3 )$$

where Nᵢ(a) and N are the number of black pixels in box i of size a and the total number of pixels in box i, respectively. The scaling of Pᵢ(a) follows the power law, Pᵢ(a)=a^{α}^{ᵢ}, where αᵢ=α(xᵢ) is the singularity exponent describing the local scaling (local fractal behavior) centered at location xᵢ of the i^{th} box, which can be estimated as

$${α}_{i} = {lim}_{a \to {0}^{+}} \frac{ln {P}_{i} ( a )}{ln ( a )} . \qquad ( 4 )$$

The multifractal spectrum f(α) is defined as the fractal dimension of the set of locations x such that α(x)=α. The f(α) spectrum represents a statistical distribution of the singularity exponents αᵢ which characterizes the local singularity strength or multifractality of the image. It is practically estimated using the Legendre transformation as

$$f ( α ) = q α - τ ( q ) , α ( q ) = \frac{d τ ( q )}{dq} , \qquad ( 5 )$$

where q is the moment and τ(q) is the mass or Holder exponent. In the multifractal formalism, D_{q}=τ(q)/(q−1) is the generalized fractal dimension, for which D₀ (q=0) is equivalent to the box-counting fractal dimension. Furthermore, the information dimension D₁ (q=1) describes the change of information entropy with the box size, whereas the correlation dimension D₂ (q=2) quantifies the correlation of fractal measures in the boxes. In addition, the width of the singularity spectrum Δα(Q)=αₘₐₓ(Q)−αₘᵢₙ(Q), where αₘₐₓ=max {α(q), q∈[−Q, Q]} and αₘᵢₙ=min{α(q), q∈[−Q, Q]}, is the measure of multifractality. The variation of the generalized fractal dimension D_{q} over a range of q, known as the Rényi spectrum, characterizes the multifractal behavior of images, with the broader range of the sigmoidal curve corresponding to the more heterogeneous scaling. The multifractal analysis was performed in this work using the MATLAB toolbox.

### (F) Statistical Analysis and Hypothesis Testing.

To determine if the differences of the estimated multifractal parameters (D₀, D₁, D₂, and Δα(4)) between the MCF-10A (normal) vs MDA-MB-231 (cancer) cell lines and SHT290 (normal) vs ES-2 (cancer) cell lines are statistically significant, two-sample t-test was performed on the measurements of the multifractal parameters, which were obtained from both AFM and KPFM (force microscopy) images. The null hypothesis states that the random samples are from normal distributions with equal means and equal but unknown variances, and the alternative hypothesis states that the samples come from populations with unequal means. We used n₁=4 and n₂=8 number of AFM images for MCF-10A vs MDA-MB-231, and n₁=5 and n₂=3 for SHT290 vs ES-2 cells. We used n₁=2 and n₂=11 number of KPFM images for MCF-10A vs MDA-MB-231, and n₁=3 and n₂=5 for SHT290 vs ES-2 cells.

A skilled person now appreciates that, as part of the article of manufacture used to implement the idea of the invention, the series of compute readable program steps was at least in one case configured to determine parameters of multifractal analysis of the second force microscopy image stored on a non-transient storage medium or received said parameters stored on the non-transient storage medium and/or at least in one case configured to determine a difference between a first width of a first multifractal spectrum of the first force microscopy image and a second width of a second multifractal spectrum of the second force microscopy image.

### Results

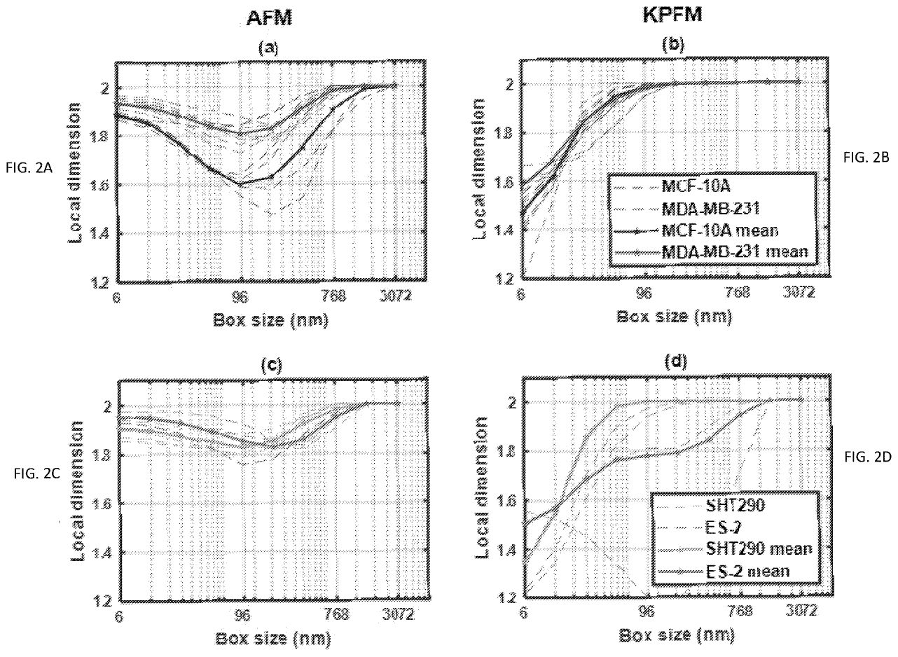

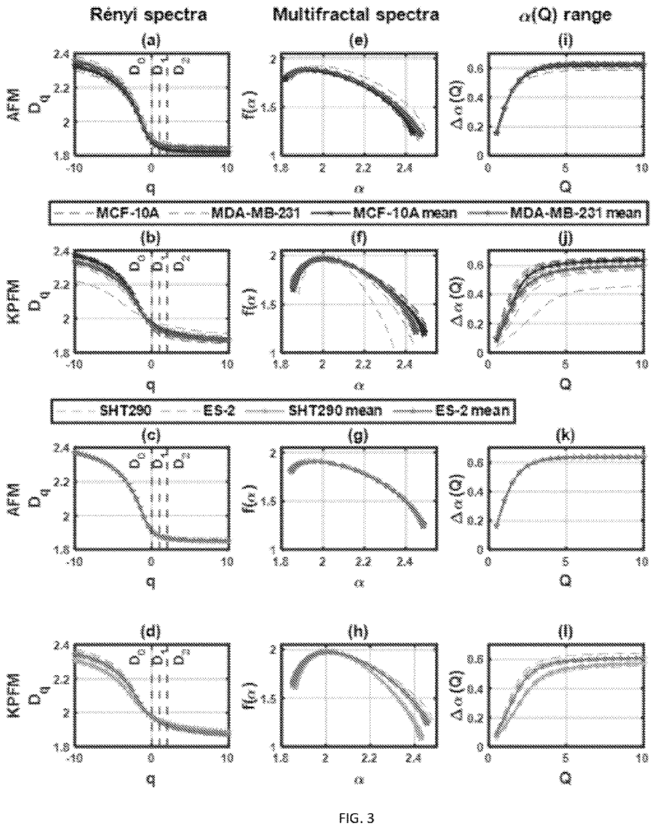

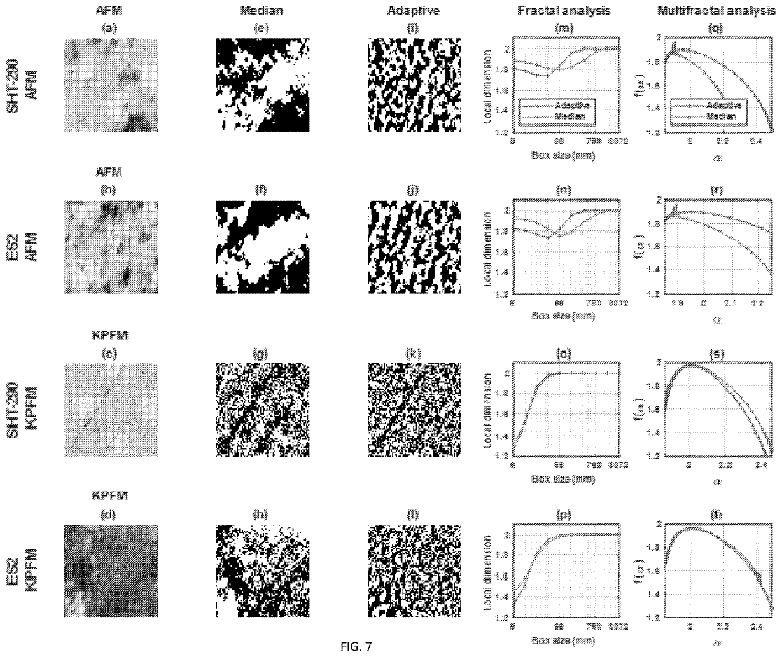

Typical representative examples of the AFM and KPFM images of the four cell lines and their corresponding binarized images, local fractal dimensions, and multifractal spectra using the adaptive and median value thresholding methods are shown in FIGS. 2 and 3 (each of which contains multiple graph-windows (a) through (t)) . . . . The thresholding values of the image binarization cut-off were estimated based on the median value of all pixels for the median method and the local mean intensity of the pixel neighborhood for the adaptive method, as described in the Methods section. The adaptive method results were more consistent and showed better statistical significance in distinguishing normal and cancer cells as described below. This may be due to the presence of the occasional random dust particles on the sample that have a large height in AFM images, affecting the median height values. This effect is minimized in the adaptive threshold method. Therefore, the adaptive threshold method was selected below to demonstrate the results. (The results obtained with the use of the median threshold method were included in FIGS. 2, 3 for comparison.) While both threshold approaches showed similar results for most of the cells, some of the data showed significant differences due to the random fluctuations, which were especially pronounced in the AFM height images. For example, graph-windows (m) and (q) of FIG. 2 show similar fractal and multifractal AFM plots for an MCF-10A cell, while graph-windows (n) and (r) of FIG. 2 evidence large differences for an MDA-MB-231 cell. However, the corresponding KPFM signals from the same cells showed similar plots in graph-windows (o), (p), (s) and (t) of FIG. 2. Similar trends are observed for the ovarian cells in FIG. 7, which showed large differences in the AFM plots and consistent results in the KPFM plots. This demonstrates the advantage of the KPFM-based approach for cancer detection as compared to the AFM-based approach: indeed, the AFM-imaging is more sensitive to ambient dust contamination that introduces large random height fluctuations, while the KPFM-imaging measures bioelectric signals that are less sensitive to random height fluctuations from the occasional uncharged particles.

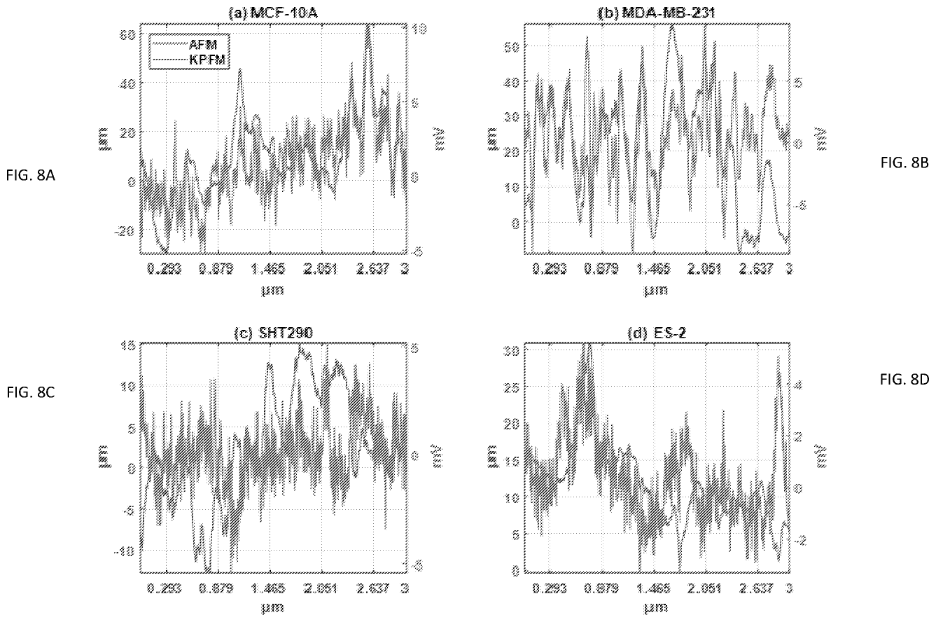

FIGS. 8A, 8B, 8C, and 8D illustrate typical representative AFM and KPFM profiles acquired by averaging 5 lines of the 3×3 μm² scan areas used in the multifractal analysis. The profiles show the amplitude and correlation between fluctuations of height (AFM) and surface potential (KPFM) of normal and cancer cells. The linear correlation coefficients between the AFM and KPFM profiles of MCF-10A, MDA-MB-231, SHT290, and ES-2 cells are 0.696, 0.434, 0.038, and 0.362, respectively. The results illustrate larger spatial fluctuations of surface potential of cancer cells compared to normal cells, characterized by fractal and multifractal analyses.

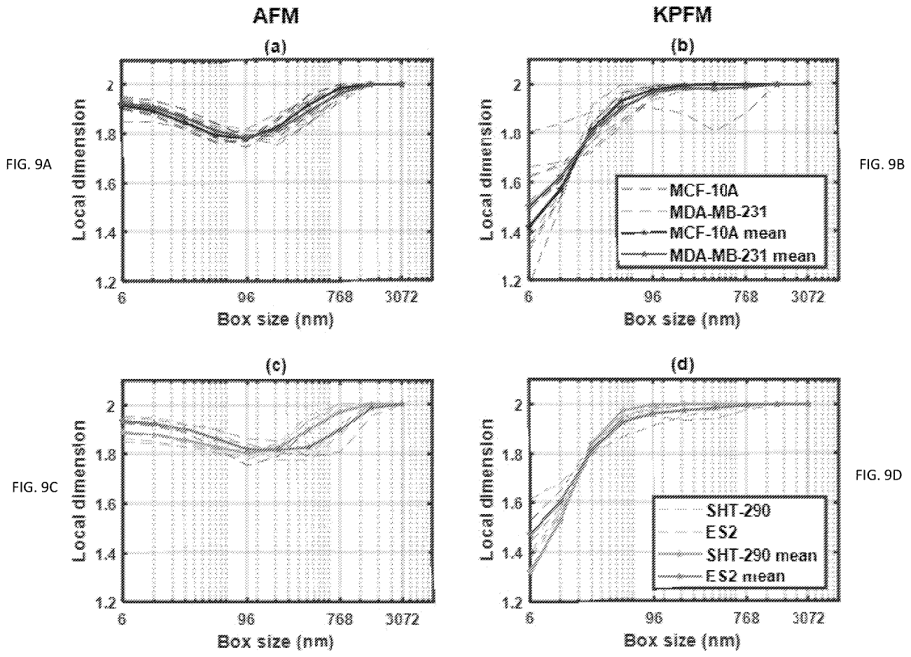

Results of Fractal analysis. First, we present the results of fractal analysis of AFM and KPFM images using the box-counting method with adaptive thresholding approach. FIGS. 2A, 2B, 2C, and 2D show the dependence of the local fractal dimension D_{f} as a function of the box size r that was obtained from the slope of the tangent of N(r) at each value of r estimated from the box-counting algorithm (D_{f}=−d ln N(r)/d ln r) (see Y. Liu et al., “An improved differential box-counting method to estimate fractal dimensions of gray-level images,” Journal of visual communication and Image Representation, vol. 25, no. 5, pp. 1102-1111, 2014). Thick solid lines correspond to the mean values, while thin dashed lines show individual cell data. The respectively-corresponding FIGS. 9A, 9B, 9C, and 9D show the corresponding results procured using the median threshold analysis. These figures show similar average trends as the examples of the individual cells described above. The results obtained with the KPFM imaging (FIGS. 2B, 2C; FIGS. 5B, 5C) provide more consistent results as compared to those procured with the AFM-imaging (FIGS. 2A, 2C; FIGS. 5A, 5C) due to the smaller sensitivity of the KPFM imaging to random particles.

As the skilled person will readily appreciate, the main insight from the fractal analysis of FIGS. 2A-2D is the observation that the local fractal dimension is not constant over the range of box sizes and varies for the different cell lines. This leads to the conclusion that both AFM and KPFM images substantially cannot be described as simple fractal objects. These images have a more complex organization, which depends on the scaling range, and beg for the use of the multifractal analysis as discussed below.

(Notably, however, fractal analysis can still be used to distinguish normal and cancer cells. It can show general trends in the variations of the local height and surface potential. For example, FIG. 2A shows smaller cell-to-cell variations in AFM local dimensions for MDA-MB-231 cells as compared to MCF-10A cells. This indicates that MDA-MB-231 cell topography is closer to being fractal than that of MCF-10A cells. MDA-MB-231 cell height variations may be approximately described by a fractal dimension of ~1.9, while the fractal dimension of MCF-10A cells varies widely within ~1.5-2 range. KPFM images show similar trends with different fractal dimensions. A smaller average range of local fractal dimensions of about 1.6 to 2 for MDA-MB-231 cells (see FIG. 2B, red solid lines) indicates a more fractal-like description compared to the broader average range of about 1.5 to 2 for MCF-10A cells (FIG. 2B, blue solid lines). Overall, both breast and ovarian cell lines exhibited a loss of multifractality upon cancerous transformation that is confirmed by the multifractal analysis below. Also, KPFM data for MDA-MB-231 cells (red dashed lines in FIG. 2B) show larger cell-to-cell variations compared to MCF-10A cells, which result reflects a larger heterogeneity of the surface potential of cancer cells compared to normal cells. The AFM fractal analysis of the ovarian cells in FIG. 2C shows similar trends, which are unable to distinguish between the normal and cancer cells. On the other hand, KPFM shows a better distinguishability in FIG. 2D. Overall, although fractal analysis may be used to distinguish between the normal and cancer cells, it is clear that the fractal analysis provides rather limited insights into the multiscale organization of both the morphology and surface potential of a given cell.)

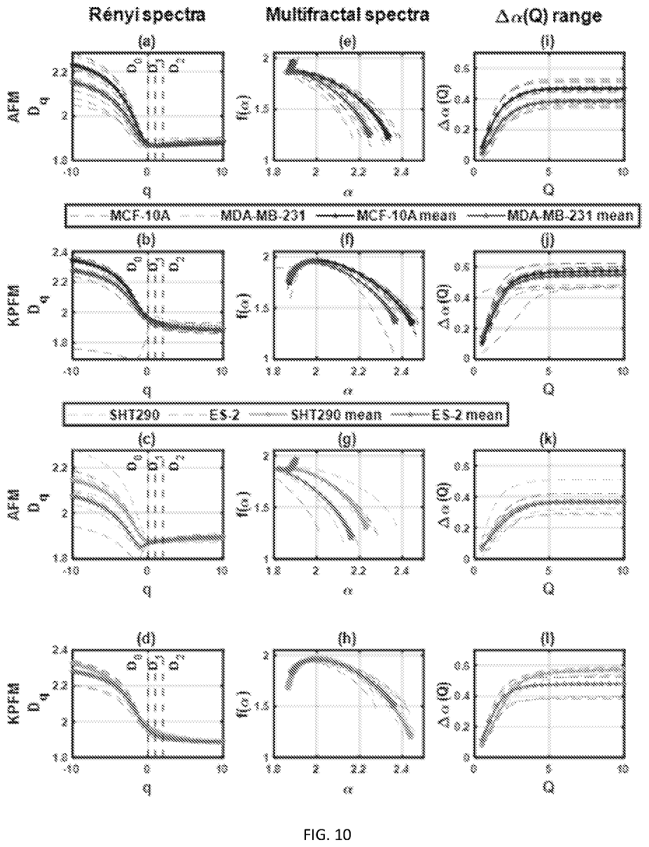

Results of Multifractal analysis. Addressing now the results of multifractal analysis of the same AFM and KPFM images of the four cell lines that were used for the fractal analysis above, FIG. 3 (which includes multiple graph-windows (a) through (l)) illustrates the Rényi spectra D_{q}, multifractal spectra f(α), and widths of multifractal spectra defined here via a singularity exponent range Δα obtained using the adaptive threshold approach. Thick solid lines show the averages over all areas of the cells including both cytoplasm and nucleus. Thin dashed lines show individual areas. The corresponding results using the median threshold approach are shown in FIG. 10 (which also contains multiple graph-windows (a) through (l)).

As the skilled artisan will readily appreciate, the Rényi spectra in graph-windows (a) through (d) of FIG. 3 show significant differences between the normal and cancer cells at D₁ and D₂ values (vertical dashed lines) in KPFM images as compared to those of AFM images. In these plots, positive q values accentuate denser regions, and negative q accentuate the less dense regions. On the contrary, the Rényi spectra show larger differences between the normal and cancer cells at D₀ for AFM images as compared to KPFM images. These results are summarized in Tables 1 and 2 below. Notably, the use of the median threshold approach did not provide satisfactory results for AFM images (see graph-windows (b) and (d) of FIG. 10) while at the same time producing satisfactory results for the KPFM images (see graph-windows (b) and (d) of FIG. 10), thereby confirming the conclusion from the fractal analysis that surface potential is less sensitive than topography to random height variations.

The multifractal spectra presented in graph-windows (e) through (h) of FIG. 3 provide direct information about the multifractality of AFM and KPFM images. Here, the concave shape of the spectra indicates multifractality, which is quantified by the width Δα. The wider spectra with the larger Δα correspond to higher multifractality. Graph-windows (e) of FIG. 3 illustrates multifractal spectra for AFM images of breast cells that have similar width Δα but different D₀, i. e. the MDA-MB-231 spectra (red lines) are shifted to higher a values. The corresponding KPFM spectra (see graph-window (f) of FIG. 3) exhibit similar shapes with similar D₀ and Δα parameters. While it may possibly be argued that the KPFM spectra in graph-window (f) of FIG. 3 cannot distinguish between the normal and cancer cells, the plots in this graph-window nevertheless quantify multifractality and provide further insights to support the results of fractal analysis presented in FIGS. 2A-2D.

The skilled person will recognize that multifractal analysis of the ovarian cells presented qualitatively different results. While no significant difference was observed in the AFM spectra (graph-window (g) of FIG. 3), there was a significant difference in the width Δα of ES-2 cells (magenta lines) having larger Δα than SHT290 (green lines) as shown in graph-window (h) of FIG. 3. Also, AFM spectra of both ES-2 and SHT290 cells showed small cell-to-cell variations in the whole a range (graph-windows (g) of FIG. 3), while KPFM spectra exhibited larger variations for ES-2 compared to SHT290 at large a values (see graph-windows (h) of FIG. 3). This evidences heterogeneity of the cancer cell surface potential despite the small variations in cell morphology.

The comparison was made of the image binarization performed with the use of the adaptive threshold based and median threshold based image binarization methods for fractal and multifractal analyses. The adaptive method showed standard concave f(α) curves for both AFM and KPFM images, while the median method failed. The adaptive method showed statistically significant differences between the KPFM multifractality for the ovarian cancer cells but the corresponding analysis using the median method showed large errors and non-concave f(α) curve shapes for AFM.

The skilled artisan readily appreciates from graph-windows (g) and (h) of FIG. 3 that the surface potential of cancer cells is more multifractal (has higher multifractality) as compared to normal, non-cancerous cells. Multifractality is more pronounced at large values of the momentum Q as shown in the Methods section above. Graph-windows (i) through (l) of FIG. 3 present the Δα(Q) plots to better visualize multifractality at different Q values. Graph-windows (k) and (l) illustrate a drastic difference between the multifractality changes of AFM and KPFM images of the ovarian cells, based on which the conclusion can be made that Δα of the surface potential of a given cell can be practically used as a cancer biomarker for such cell.

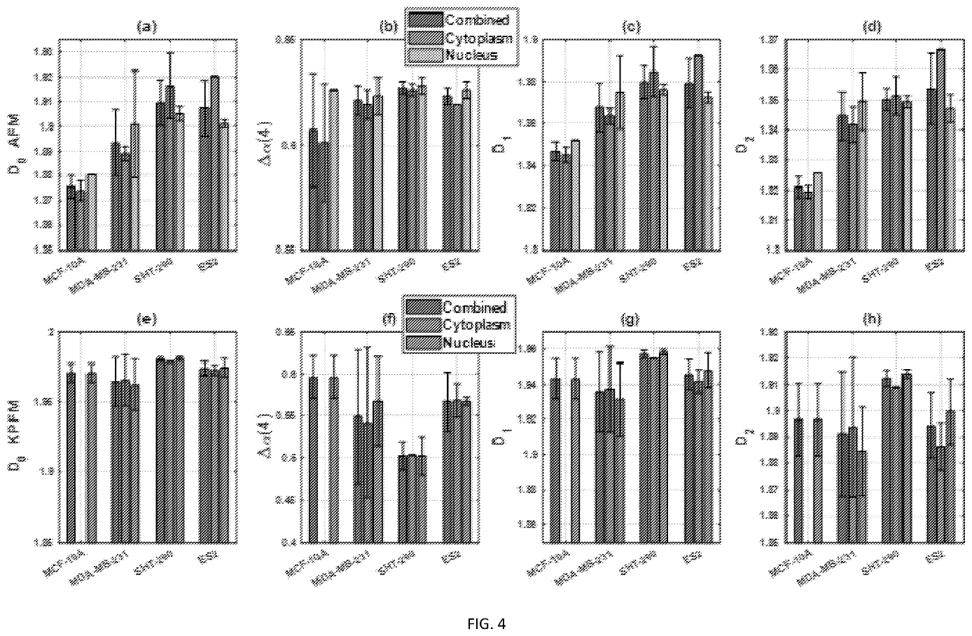

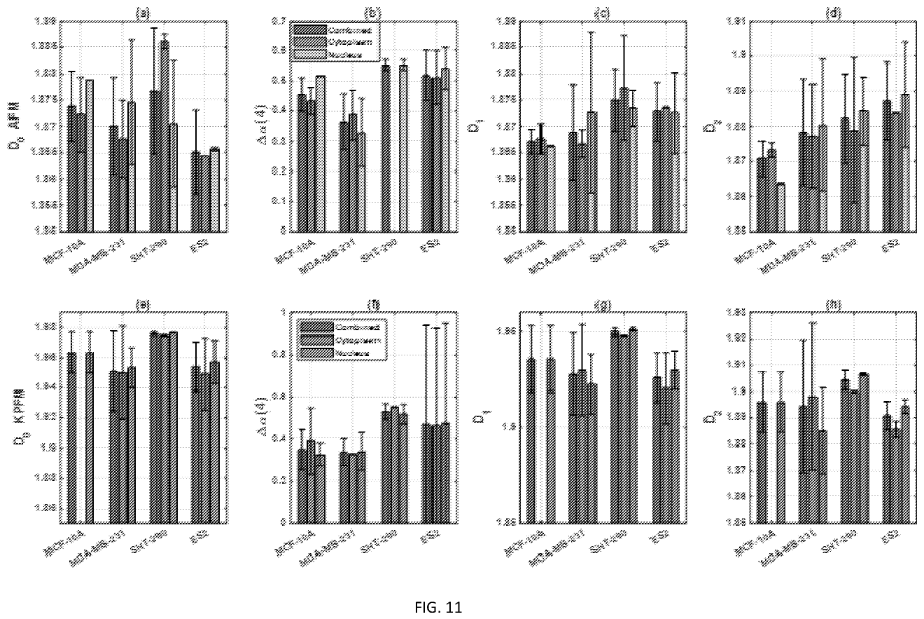

FIG. 4 (which includes multiple graph-windows (a) through (h), organized in two rows—with the first row containing graph-windows (a) through (d) that represent parameters of multifractal analysis of the AFM images and the second row containing graph-windows (e) through (H) that represent parameters of multifractal analysis of the KPFM images) shows the comparison of the parameters D₀, D₁, D₂, and Δα(4) from the cytoplasm, nucleus, and combined regions using the adaptive threshold approach. The corresponding results using the median threshold approach are shown in FIG. 11 (the multiple graph-windows (a) through (h) of which respectively correspond to those of FIG. 4). Graph-windows (a), (c), and (d) of FIG. 4 evidence that D₀, D₁, and D₂ parameters of multifractal analysis of the AFM images of MCF-10A are lower than those of MDA-MB-231 (D₀ at p<0.05; D₁ at p<0.01; D₂ at p<0.001; see Table 1). These differences indicate the increase of the morphological local fractal dimension and heterogeneity (disorder) in breast cancer cells. Graph-windows (b) of FIG. 4 shows no substantial difference in the mean value of Δα(4) of the AFM images of the four cell types but MCF-10A cells showed the largest variance of Δα(4).

Based on results displayed in FIG. 4, the person of ordinary skill in the art will recognize that behaviors of the AFM-image based and KPFM-image based multifractal parameters are substantially opposite to one another. In particular, graph-windows (e), (g), and (h) of FIG. 4 present that D₀, D₁, and D₂ of KPFM images of SHT290 are larger than those of ES-2 (p<0.1; Table 2), which indicates the lower local fractal dimension of surface potential in ovarian cancer cells compared to normal endometrial cells. However, the D₀, D₁, and D₂ parameters have larger variations for ES-2 compared to SHT290 cells, possibly reflecting a larger heterogeneity of the cancer cells. FIG. 4f shows a larger mean value of Δα(4) for ES-2 compared to SHT290 (p<0.05), indicating larger multifractality of the ovarian cancer cell surface potential. No significant difference between the mean values of the surface potential Δα(4) were found for MCF-10A and MDA-MB-231 cells. However, the MDA-MB-231 cells showed larger variations of Δα(4).

The hypothesis testing results for the differences in the multifractal parameters of AFM and KPFM images using the adaptive method are shown in Tables 1 and 2. The hypothesis testing for the mean difference in the multifractal parameters of AFM images revealed the significant differences in D₀, D₁, and D₂ between the MCF-10A and MDA-MB-231 cell lines at the significance level of 0.05, but no significant difference in Δα(4) was found (Table 1). However, for the ovarian cell lines, no significant differences in the four multifractal parameters of the AFM images of SHT290 and ES-2 cell lines were identified.

TABLE 1
Hypothesis testing for the difference in the multifractal parameters (box
counting dimension D₀, entropy dimension D₁, correlation dimension D₂, and
singularity exponent range Δα(4)) of AFM images using the adaptive method.

| Hypothesis testing | Sample pair | X̅₁ ± s₁ | X̅₂ ± s₂ | p-value |
|---|---|---|---|---|
| Mean difference in D₀ | MCF-10A vs MDA-MB-231 | 1.876 ± 0.005 | 1.894 ± 0.013 | 0.0286 *^{a} |
| | SHT290 vs ES-2 | 1.909 ± 0.009 | 1.907 ± 0.011 | 0.7801 |
| Mean difference in D₁ | MCF-10A vs MDA-MB-231 | 1.847 ± 0.005 | 1.868 ± 0.011 | 0.0059** |
| | SHT290 vs ES-2 | 1.880 ± 0.008 | 1.880 ± 0.012 | 0.9429 |
| Mean difference in D₂ | MCF-10A vs MDA-MB-231 | 1.821 ± 0.004 | 1.845 ± 0.008 | 0.0002*** |
| | SHT290 vs ES-2 | 1.850 ± 0.004 | 1.854 ± 0.012 | 0.5434 |
| Mean difference in Δα(4) | MCF-10A vs MDA-MB-231 | 0.607 ± 0.027 | 0.621 ± 0.007 | 0.1793 |
| | SHT290 vs ES-2 | 0.627 ± 0.003 | 0.623 ± 0.004 | 0.1615 |

^{a} Significance codes: p < 0.001 ‘***’, p < 0.01 ‘**’, p < 0.05 ‘*’

TABLE 2
Hypothesis testing for the difference in the multifractal parameters (box counting
dimension D₀, entropy dimension D₁, correlation dimension D₂, and singularity
exponent range Δα(4)) of KPFM images using the adaptive method.

| Hypothesis testing | Sample pair | X̅₁ ± s₁ | X̅₂ ± s₂ | p-value ^{a} |
|---|---|---|---|---|
| Mean difference in D₀ | MCF-10A vs MDA-MB-231 | 1.971 ± 0.007 | 1.964 ± 0.017 | 0.6354 |
| | SHT290 vs ES-2 | 1.980 ± 0.002 | 1.974 ± 0.005 | 0.0821 • |
| Mean difference in D₁ | MCF-10A vs MDA-MB-231 | 1.943 ± 0.011 | 1.936 ± 0.023 | 0.6645 |
| | SHT290 vs ES-2 | 1.957 ± 0.002 | 1.946 ± 0.009 | 0.0656 • |
| Mean difference in D₂ | MCF-10A vs MDA-MB-231 | 1.897 ± 0.014 | 1.845 ± 0.008 | 0.7685 |
| | SHT290 vs ES-2 | 1.912 ± 0.003 | 1.894 ± 0.012 | 0.0536 • |
| Mean difference in Δα(4) | MCF-10A vs MDA-MB-231 | 0.596 ± 0.025 | 0.549 ± 0.079 | 0.4339 |
| | SHT290 vs ES-2 | 0.502 ± 0.017 | 0.567 ± 0.035 | 0.0256* |

^{a} Significance codes: p < 0.05 ‘*’, p < 0.1 ‘•’

In contrast to the hypothesis testing results of the AFM images, the hypothesis tests for the KPFM images mean difference in D₀, D₁, and D₂ showed the substantial differences between the SHT290 and ES-2 cell lines at the significance level of 0.1 and the significant difference in Δα(4) at the level of 0.05, but there were no significant differences between MCF-10A and MDA-MB-231 cell lines in terms of the four multifractal parameters (Table 2).

The observed differences between the morphological and surface potential measurements can be explained by the molecular structural and bioelectric changes of the plasma membrane. The presented suggest that AFM and KPFM are complementary imaging techniques reflecting different molecular mechanisms of tumorigenesis, such as the expression of membrane surface proteins, activity of ion channels and cytoskeletal reorganization. In the case of ovarian cancer cells (i.e., normal-immortalized SHT290 and tumorigenic ES-2), KPFM provides significant differences in multifractality, while AFM does not. These observations agree with the molecular model of ovarian cancer based on the overexpression of certain proteins such as the protein kinase C (PKC) family (see, for example, E. M. Griner and M. G. Kazanietz, “Protein kinase C and other diacylglycerol effectors in cancer,” Nature Reviews Cancer, vol. 7, no. 4, pp. 281-294, 2007).

Although ovarian ES-2/SHT290 cells exhibited a larger depolarization compared to breast MCF-10A/MDA-MB-231, of note is the higher variance among both tissue types in the cancerous cell lines compared to their normal-immortalized counterparts. The smaller size of the ovarian (~10-15 μm) compared to breast (~20-30 μm) and the small sample size may be the reason that our results on multifractality did not show a significant difference between the MCF-10A and MDA-MB-231 cells. Based on the larger difference in surface potential, a conclusion can be made that the proposed technique for identification of the cancerous nature of a target cell with the use of multifractal analysis of image(s) representing spatial distribution of an electrostatic characteristic of the cell—such as its surface potential—may also be applied at least to pancreatic, hepatic, and rectal cancers.

Notably, all imaging procedures were performed under steady-state conditions, in which the sub-millisecond temporal fluctuations of surface potential were averaged out. Therefore, the presented work focused on spatial fluctuations. Some recent work on temporal dynamics of the surface potential revealed larger fluctuations in MDA-MB-231 cells as compared to MCF-10A cells (see P. Quicke et al., “Voltage imaging reveals the dynamic electrical signatures of human breast cancer cells,” Communications Biology, vol. 5, no. 1, p. 1178, 2022); there, the potential fluctuations in cancer cells discussed in this work were inhibited by the voltage-gated Na channel and Ca²⁺-activated K channel blockers, which indicates the possible role of the ion channels in modifying the membrane morphology that we measured in our AFM experiments. However, the measurements discussed by P. Quicke were performed using voltage-sensitive dyes (and for that reason alone were invasive) and were not label-free. IN stark and advantageous contradistinction, the KPFM measurements discussed in this disclosure are label-free and substantially non-invasive.

The discussed embodiments are implementations of a novel and non-obvious idea of utilizing specific parameters of multifractal analysis of force microscopy images that represent an electrostatic characteristic of a cell being imaged to identify whether such cell is cancerous or not. In particular, the use of multifractality of images of a surface potential of a biological cell is used for the first time for this purpose.

As understood by a skilled artisan, and while not necessarily expressly shown in the Figures, implementation of at least some of embodiments of the invention may require the use of a processor controlled by instructions stored in a memory—for example, for collection of optical data characterizing the operation of an apparatus of the invention. Such memory may be random access memory (RAM), read-only memory (ROM), flash memory or any other memory, or combination thereof, suitable for storing control software or other instructions and data. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

Understandably, a computer program product containing program code(s) embodying and/or governing the operation of at least one implementation of the idea of the invention remain within the scope of the invention.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes. Other specific examples of the meaning of the terms “substantially”, “about”, and/or “approximately” as applied to different practical situations may have been provided elsewhere in this disclosure.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

The term “image” is defined to refer to an ordered representation of the used detector output corresponding to spatial positions. For example, a visual image may be formed, in response to a pattern of light detected by an optical detector, on a display device X such as a video screen or printer, while an image representing spatial distribution of a surface potential may be formed in response to a measurement of the electric potential with the use of the appropriate electronic circuitry, as recognized by a skilled person.

For the purposes of this disclosure and the appended claims, the expression of the type “element A and/or element B” is defined to have the meaning that covers embodiments having element A alone, element B alone, or elements A and B taken together and, as such, is intended to be equivalent to “at least one of element A and element B”.

While the invention is described through the above-described specific non-limiting embodiments, it will be understood by those of ordinary skill in the art that modifications to, and variations of, the illustrated embodiments may be made without departing from the inventive concepts disclosed herein. The disclosed aspects may be combined in ways not listed above. Accordingly, the invention should not be viewed as being limited to the disclosed embodiment(s).

1. Use of an apparatus configured to acquire a first image of a spatial distribution of an electrostatic characteristic of a target biological cell and to perform, with the use of a processor, multifractal analysis of the first image to identify whether the target biological cell is a cancerous cell.

2. The use according to claim 1, wherein the apparatus is configured to generate user-perceivable indicia representing whether the biological cell is the cancerous cell.

3. The use according to one of claims 1 and 2, wherein the electrostatic characteristic includes a difference between a surface potential of a surface of the cell and a surface potential of an electrically conducting element moving above the surface of the biological cell.

4. The use according to one of claims 1 to 3, wherein the apparatus includes a force microscope configured to produce said first image.

5. The use according to one of claims 1 to 4, wherein the processor is further configured to procure a second image of a spatial distribution of an electrostatic characteristic of a reference biological cell that is nonmalignant and to determine whether a difference between a first parameter of the multifractal analysis of the first image and a second parameter of the multifractal analysis of the second image.

6. The use according to claim 5, wherein each of the first parameter and the second parameter includes at least one of:
(6A) a parameter of a Rényi spectrum of the first image and the second image, respectively, determined with the use of a mean value thresholding; and
(6B) a width of a multifractal spectrum of the first image and the second image, respectively, determined with the use of adaptive thresholding;

7. The use according to claim 6,
wherein, when each of the first parameter and the second parameter includes a parameter of the corresponding Rényi spectrum, such parameter of the corresponding Rényi spectrum comprises an entropy dimension D₁ and/or a correlation dimension D₂ and/or
wherein, when each of the first parameter and the second parameter includes a width of a corresponding multifractal spectrum, said width is defined by a singularity exponent range Δα(4).

8. The use according to one of claims 5 to 7, wherein said indicia represents a difference between the first parameter and the second parameter.

9. Use of a Kelvin probe force microscopic imaging of a target biological cell to identify the biological cell as a cancerous cell or as a nonmalignant cell by assessing a first width of a multifractal spectrum of a spatial distribution of a surface potential of the target biological cell.

10. The use of claim 9, comprising assessing a second width of a multifractal spectrum of a spatial distribution of a surface potential of a reference nonmalignant biological cell and identifying the target biological cell as the cancerous cell when the first width is substantially smaller than the second width.

11. An article of manufacture comprising:
a processor; and
a non-transitory computer readable medium comprising computer readable program code disposed therein for controlling operation of an apparatus comprising:
a force microscope configured to characterize a surface potential of a target biological sample;
wherein the computer readable program code comprises a series of computer readable program steps to effect:
acquiring a first force microscopy image representing the surface potential of the target biological sample;
providing a second force microscopy image representing a surface potential of a reference biological sample that is nonmalignant; and
comparing results of multifractal analysis of the first and second force microscopy images.

12. An article of manufacture according to claim 9, wherein the series of compute readable program steps is configured to determine parameters of multifractal analysis of the second force microscopy image stored on a non-transient storage medium or received said parameters stored on the non-transient storage medium.

13. An article of manufacture according to one of claims 11 and 12, wherein the computer readable program steps are configured to further effect:
determining a difference between a first width of a first multifractal spectrum of the first force microscopy image and a second width of a second multifractal spectrum of the second force microscopy image.

14. An article of manufacture according to claim 13, wherein said determining includes determining a difference between widths of first and second singularity multifractal spectra of the respectively corresponding first and second force microscopy images.

15. An article of manufacture according to one of claims 11 to 14, wherein the computer readable program steps are configured to carry out
producing indicia identifying the biological sample as a cancerous biological sample when the first width is substantially larger than the second width.

16. A computer implemented method for identifying a cancerous biological cell, the method comprising:
acquiring, with the computer, a first image of a target biological cell and a second image of a reference nonmalignant biological cell, wherein each of the first image and the second image represents a spatial distribution of surface potential of a corresponding biological cell of the target and reference nonmalignant cells;
performing, with the computer, (i) multifractal analysis of the first image to generate a first multifractal characteristic representing the chosen biological cell, and (ii) multifractal analysis of the second image to generate a second multifractal characteristic representing the reference nonmalignant biological cell; and
creating, with the computer, indicia representing whether the chosen biological cell is the cancerous biological cell based on a difference between a first parameter of the first characteristic and a second parameter of the second characteristic.

17. A computer implemented method according to claim 16, wherein each of the first and second characteristics includes at least one of a Rényi spectrum, a multifractal spectrum, and a singularity exponent range.

18. A computer implemented method according to one of claims 16 and 17, wherein said creating includes determining at least one of
(18A) a difference between entropy dimensions D₁ of the respectively corresponding Rényi spectra of the first and second images;
(18B) a difference correlation dimensions D₂ of the respectively corresponding Rényi spectra of the first and second images; and
(18C) a difference between widths of respectively corresponding multifractal spectra of the first and second images.

19. A computer implemented method according to one of claims 16 to 18, further comprising:
operating a force microscope apparatus while maintaining a tip-to-sample potential (TSP) difference to remain substantially constant to acquire each of the first and second images,
wherein the TSP difference is a difference between a surface potential of a tip of a probe of the force microscope and a surface potential of the corresponding biological cell of the target and reference nonmalignant cells.

20. A computer implemented method according to claim 19, wherein the tip is coated with an electrically conducting material.

21. A computer implemented method according to one of claims 16 to 20, wherein, when the first parameter and the second parameter are, respectively, a first width of a multifractal spectrum of the first image and a second width of a multifractal spectrum of the second image, said creating includes identifying whether the second width is greater than the first width.

22. A computer implemented method according to one of claims 16 to 21, wherein, when the first parameter and the second parameter are, respectively, a first width of a multifractal spectrum of the first image and a second width of a multifractal spectrum of the second image, each of said first and second widths is determined with the use of an adaptive thresholding as a corresponding singularity exponent range of, respectively, the multifractal spectrum of the first image and the multifractal spectrum of the second image.

23. A computer implemented method according to one of claims 16 to 22, wherein said acquiring includes acquiring the first and second images with a nanoscale resolution.
